(19) United States
(12) Patent Application Publication
(10) Pub. No.: US 2025/0385341 A1
(43) Pub. Date: Dec. 18, 2025

(54) INSULATION SHEET AND BATTERY MODULE HAVING THE SAME

(71) Applicant: SAMSUNG SDI CO., LTD., Yongin-si (KR)

(72) Inventors: Jae Hyun LEE, Suwon-si (KR); Myung Heui WOO, Suwon-si (KR); Jung Hyo LEE, Suwon-si (KR); Seung Yong YANG, Suwon-si (KR); Hye Jin PARK, Suwon-si (KR); Ha Na RA, Suwon-si (KR); Yun Sung YANG, Suwon-si (KR)

(73) Assignee: SAMSUNG SDI CO., LTD., Yongin-si (KR)

(21) Appl. No.: 19/228,150

(22) Filed: Jun. 4, 2025

(30) Foreign Application Priority Data
Jun. 13, 2024 (KR) 10-2024-0077076

(51) Int. Cl. H01M 10/658; B32B 3/30; H01M 10/647; H01M 50/209; H01M 50/211

(52) U.S. Cl. CPC H01M 10/658; B32B 3/30; H01M 10/647; H01M 50/209; H01M 50/211; B32B 2250/03; B32B 2250/40; B32B 2307/304; B32B 2457/10

(57) ABSTRACT

The present disclosure relates to an insulation sheet, and is directed to an insulation sheet improving heat propagation when heat propagation occurs within a battery module. The present disclosure provides an insulating sheet including two first layers, and a second layer located between the two first layers and including an insulation material, wherein at least one surface of the insulation sheet is formed with a bending portion.

### CROSS-REFERENCE TO RELATED APPLICATION

The present application claims priority to Korean Patent Application No. 10-2024-0077076, filed on Jun. 13, 2024 in the Korean Intellectual Property Office, the entire disclosure of which is incorporated herein by reference.

### BACKGROUND

### 1. Field of the Disclosure

The present disclosure relates to an insulation sheet and to a battery module to which an insulating sheet is applied.

### 2. Description of the Related Art

Batteries can be charged and discharged, unlike primary batteries that cannot be recharged. Low-capacity batteries are used in portable small electronic devices such as, e.g., smartphones, feature phones, laptop computers, digital cameras, and camcorders, while high-capacity batteries are typically used as power sources for, e.g., motor driving in hybrid vehicles, electric vehicles, and the like, and batteries for power storage, or the like. These batteries include electrodes including a positive electrode and/or a negative electrode, an electrode assembly including the electrodes, a case accommodating the electrode assembly, an electrode terminal connected to the electrode assembly, and the like.

As technology advances, high-capacity batteries are advantageous. Accordingly, a plurality of batteries may be used by being electrically connected. For example, the batteries may be applied to electronic devices in the form of a battery module including a plurality of batteries and/or a battery pack including a plurality of battery modules. In this case, the electronic devices are electronic devices that typically require high output and/or high capacity and include, for example, electric vehicles, and the like.

High capacity secondary batteries may be in the form of a module and/or a pack in which a plurality of secondary batteries are stacked. However, because the plurality of secondary batteries are typically disposed adjacent to each other, heat propagation between adjacent cells may become easier. When thermal runaway occurs in one cell, this thermal runaway may readily propagate to adjacent cells, thereby causing safety risks such as fire.

Therefore, improving heat propagation between adjacent cells may be advantageous.

The above-described information disclosed in the background technology of the disclosure is only intended to provide a better understanding of the background of the present disclosure, and therefore information that does not constitute the related art may be included.

### SUMMARY OF THE DISCLOSURE

Examples of the present disclosure are directed to an insulation sheet and/or a battery module including the insulation sheet, which reduces or prevents heat propagation.

Examples of the present disclosure are directed to an insulation sheet and/or a battery module including the insulation sheet, which has improved fire resistance properties.

Examples of the present disclosure are directed to an insulation sheet and/or a battery module including the insulation sheet, which is capable of enclosing a battery cell through one sheet.

Examples of the present disclosure are directed to providing an insulation sheet and/or a battery module including the insulation sheet, which is capable of being utilized by being cut in various ways according to an enclosing area.

However, the technical objects to be achieved by the present disclosure are not limited to the above-described objects, and other objects not mentioned can be understood by those skilled in the art from the following description of the disclosure.

According to an example aspect, an insulation sheet according to one example embodiment of the present disclosure includes two first layers, and a second layer located between the two first layers and including an insulation material, wherein at least one surface of the insulation sheet may be formed with or include a bending portion.

According to another example aspect, a battery module according to one example embodiment of the present disclosure includes a plurality of battery cells and an insulation sheet surrounding at least a portion of at least one of the plurality of battery cells, wherein the insulation sheet may include two first layers and a second layer located between the two first layers and including an insulation material, and at least one surface of the insulation sheet may be formed with or include a bending portion.

### BRIEF DESCRIPTION OF THE DRAWINGS

The following drawings attached to the present specification illustrate example embodiments of the present disclosure and further describe the technical spirit of the present disclosure along with the detailed description described below, and therefore the present disclosure should not be interpreted as being limited to the features and elements described in such drawings, in which:

FIGS. 1 to 3 are cross-sectional views schematically showing a battery cell, according to one example embodiment of the present disclosure;

FIG. 4 is a view showing a battery module according to one example embodiment of the present disclosure;

FIG. 5 is a cross-sectional view schematically showing an insulation sheet according to one example embodiment of the present disclosure;

FIG. 6 is a cross-sectional view schematically showing an insulation sheet according to one example embodiment of the present disclosure;

FIG. 7 is a cross-sectional view schematically showing an insulation sheet according to one example embodiment of the present disclosure;

FIG. 8 is a cross-sectional view schematically showing an insulation sheet according to one example embodiment of the present disclosure; and

FIG. 9 is a view schematically showing an example in which the insulating sheet according to one example embodiment of the present disclosure is applied to a battery cell.

### DETAILED DESCRIPTION OF EXEMPLARY EMBODIMENTS

Hereinafter, example embodiments of the present disclosure are described in detail. However, these embodiments are presented as examples, the present disclosure is not limited thereto, and the present disclosure is only defined by the scope of the appended claims.

Unless otherwise stated herein, when a part such as a layer, a film, a region, or a plate is described as being “on” another part, this includes not only a case where the part is “directly on” the other part, but also a case where there are other parts therebetween.

Unless otherwise defined herein, a particle diameter may be an average particle diameter. In addition, unless otherwise specified, “A or B” may mean “including A, including B, or including A and B.”

As used herein, “a combination thereof” may mean a mixture, a laminate, a composite, a copolymer, an alloy, a blend, a reaction product of constituents, or the like.

Unless otherwise defined herein, a particle diameter may be an average particle diameter. In addition, the particle diameter is an average particle diameter D50 which refers to the diameter of particles whose cumulative volume is 50 vol % in a particle size distribution. The average particle diameter D50 may be measured by methods well known to those skilled in the art, for example, a particle diameter analyzer, a transmission electron micrograph, a scanning electron micrograph, or the like. As another method, the average particle diameter D50 value may be obtained by measuring the particle diameters using a measurement device using dynamic light scattering, conducting data analysis, counting the number of particles in each particle diameter range, and then calculating the average particle diameter therefrom. Alternatively, the average particle diameter may be measured using a laser diffraction method. For example, when measuring the average particle diameter by the laser diffraction method, after the particles to be measured are dispersed in a dispersion medium, the particles may be introduced into a commercially available laser diffraction particle diameter measuring device (e.g., Microtrac MT 3000) and irradiated with ultrasonic waves of about 28 kHz at an output of 60 W, and the average particle diameter (D50) based on 50% of the particle diameter distribution in the measurement device may be calculated.

When the terms “about” or “substantially” are used in this specification in connection with a numerical value, it is intended that the associated numerical value include a tolerance of 10% around the stated numerical value. When ranges are specified, the range includes all values therebetween such as increments of 0.1%.

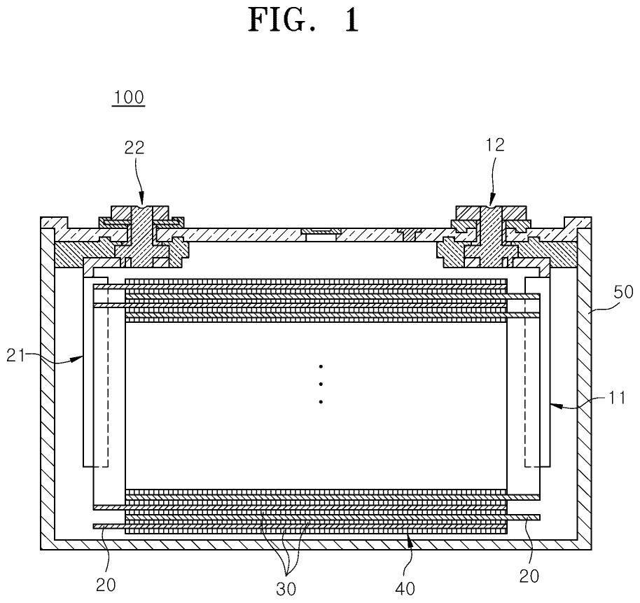

FIGS. 1 to 3 are cross-sectional views schematically showing a battery cell according to one example embodiment of the present disclosure;

### Battery Cell 100

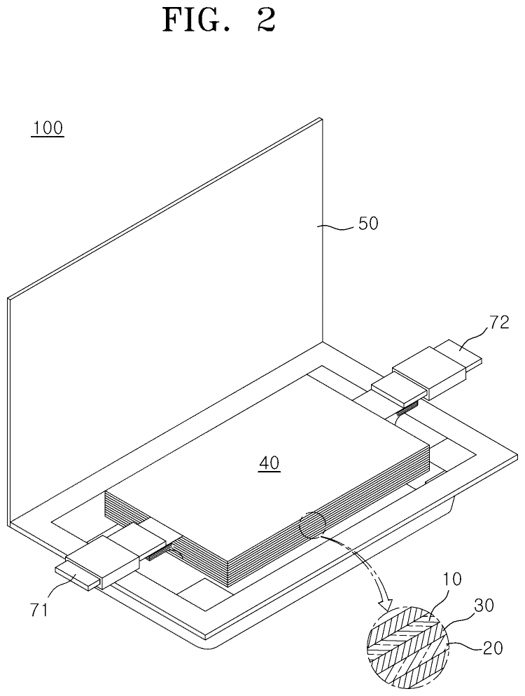

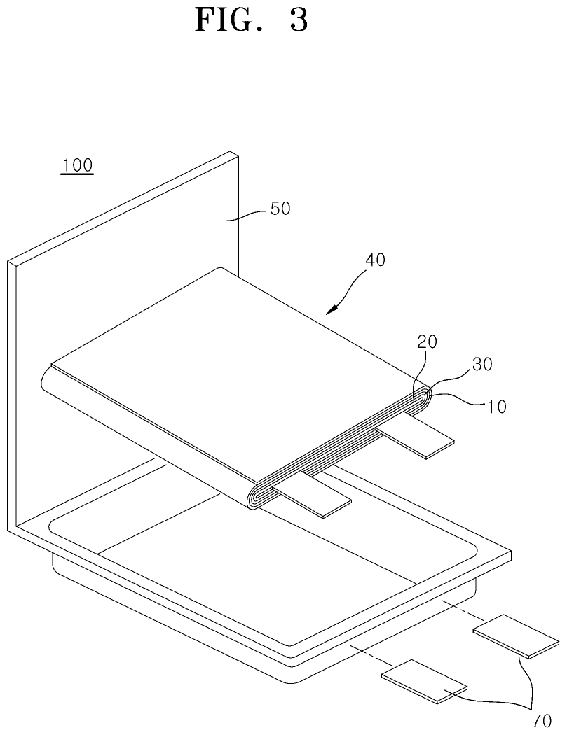

A battery cell 100 may be classified as a cylindrical shape, a prismatic shape, a pouch shape, a coin shape, and the like, depending on the shape thereof. FIGS. 1 to 3 are schematic views showing battery cells according to one example embodiment of the present disclosure, and FIG. 1 shows a prismatic battery, and FIGS. 2 and 3 show a pouch-shaped battery. Referring to FIGS. 1 to 3, the battery cell 100 may include an electrode assembly 40 with a separator 30 interposed between a positive electrode 10 and a negative electrode 20, and a case 50 in which the electrode assembly 40 is accommodated. The positive electrode 10, the negative electrode 20, and the separator 30 may be impregnated with an electrolyte (not shown). As shown in FIG. 1, the battery cell 100 may include a positive electrode lead tab 11, a positive electrode terminal 12, a negative electrode lead tab 21, and a negative electrode terminal 22. As shown in FIGS. 2 and 3, the battery cell 100 may include electrode tabs 70 illustrated in FIG. 3, and for example a positive electrode tab 71 and a negative electrode tab 72 illustrated in FIG. 2, the electrode tabs 70/71/72 forming an electrical passage to guide a current generated in the electrode assembly 40 to the outside of the battery cell 100.

The battery cell 100 to which one example embodiment of the present disclosure is applied is not limited to the shapes described in FIGS. 1 to 3, and one example embodiment of the present disclosure may be applied to any type of battery cell 100.

### Positive Electrode Active Material

As a positive electrode active material, a compound capable of reversible intercalation and deintercalation of lithium (a lithiated intercalation compound) may be used. For example, one or more of composite oxides of lithium and a metal such as or including at least one of cobalt, manganese, nickel, and a combination thereof may be used.

The composite oxide may be or include a lithium transition metal composite oxide, and examples thereof may include at least one of a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any of the following formulas may be used:

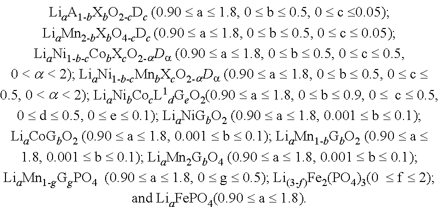

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof, D is or includes at least one of O, F, S, P, or a combination thereof, G is or includes at least one of Al, Cr, Mn, Fe, Mg, La, Ce, Sr, V, or a combination thereof, and L1 is or includes at least one of Mn, Al, or a combination thereof.

As an example, the positive electrode active material may be or include a high nickel-based positive electrode active material with a nickel content of about 80 mol % or more, 85 mol % or more, 90 mol % or more, 91 mol % or more, or 94 mol % or more and 99 mol % or less based on 100 mol % of metal excluding lithium in the lithium transition metal composite oxide. The high nickel-based positive electrode active material can exhibit high capacity, and thus can be applied to high capacity, high density lithium batteries.

### Positive Electrode 10

The positive electrode 10 for the battery cell 100 may include a current collector and a positive electrode active material layer formed on the current collector. The positive electrode active material layer may include the positive electrode active material, and may further include a binder and/or a conductive material.

As an example, the positive electrode may further contain an additive that may be configured as a sacrificial positive electrode.

The content of the positive electrode active material may range from about 90 wt % to about 99.5 wt % based on 100 wt % of the positive electrode active material layer, and the content of the binder and the conductive material may each range from about 0.5 wt % to about 5 wt % based on 100 wt % of the positive electrode active material layer.

The binder may be configured to attach the positive electrode active material particles to each other, and to attach the positive electrode active material to the current collector. Representative examples of the binder may include at least one of polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinyl pyrrolidone, polyurethane, polytetrafluoroethylene, polyvinylidene fluoride, polyethylene, polypropylene, styrene-butadiene rubber, (meth)acrylated styrene-butadiene rubber, an epoxy resin, a (meth)acrylic resin, a polyester resin, nylon, and the like, but are not limited thereto.

The conductive material may be included to impart conductivity to the electrode, and in a configured battery, any electronically conductive material that does not cause a chemical change may be included. Examples of the conductive material may include a carbon-based material such as at least one of natural graphite, artificial graphite, carbon black, acetylene black, Ketjen black, carbon fibers, carbon nanofibers, carbon nanotubes; a metal-based material including at least one of copper, nickel, aluminum, silver, and the like, and in the form of a metal powder or metal fibers; a conductive polymer such as a polyphenylene derivative; or a mixture thereof.

Al may be included as the current collector but it is not limited thereto.

### Negative Electrode Active Material

The negative electrode active material may include at least one of a material capable of reversible intercalation/deintercalation of lithium ions, lithium metal, an alloy of lithium and a metal, a material capable of doping and dedoping lithium, or a transition metal oxide.

The material capable of reversible intercalation/deintercalation of lithium ions may be or include a carbon-based negative electrode active material, and may include, for example, crystalline carbon, amorphous carbon, or a combination thereof. Examples of the crystalline carbon may include graphite, such as amorphous, plate-like, flaky, spherical, or fibrous natural graphite or artificial graphite, and examples of the amorphous carbon may include at least one of soft carbon, hard carbon, mesophase pitch carbide, calcined coke, and the like.

As the alloy of lithium and a metal, an alloy of lithium and a metal such as or including at least one of Na, K, Rb, Cs, Fr, Be, Mg, Ca, Sr, Si, Sb, Pb, In, Zn, Ba, Ra, Ge, Al, and Sn may be included.

An Si-based negative electrode active material or an Sn-based negative electrode active material may be included as the material capable of doping and dedoping lithium. The Si-based negative electrode active material may include at least one of silicon, a silicon-carbon composite, SiOₓ (0<x<2), a Si-Q alloy (Q is or includes at least one of an alkali metal, an alkaline earth metal, a group 13 element, a group 14 element (excluding Si), a group 15 element, a group 16 element, a transition metal, a rare earth element, and a combination thereof), or a combination thereof. The Sn-based negative electrode active material may be or include at least one of Sn, SnO₂, an Sn-based alloy, or a combination thereof.

The silicon-carbon composite may be or include a composite of silicon and amorphous carbon. According to one example embodiment, the silicon-carbon composite may be in the form of silicon particles which surface is coated with amorphous carbon. For example, the silicon-carbon composite may include a secondary particle (core) in which silicon primary particles are assembled, and an amorphous carbon coating layer (shell) located on a surface of the secondary particle. The amorphous carbon may also be located between the silicon primary particles, for example, the silicon primary particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer located on the surface of the core.

The Si-based negative electrode active material or the Sn-based negative electrode active material may be included in combination with a carbon-based negative electrode active material.

### Negative Electrode 20

The negative electrode 20 for the battery cell 100 may include a current collector and a negative electrode active material layer located on the current collector. The negative electrode active material layer may contain a negative electrode active material, and may further include a binder and/or a conductive material.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may be configured to attach the negative electrode active material particles, and to attach the negative electrode active material to the current collector. The binder may be or include at least one of a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamide-imide, polyimide, or a combination thereof.

The aqueous binder may be or include at least one of styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenolic resin, an epoxy resin, polyvinyl alcohol, and a combination thereof.

When an aqueous binder is included as the negative electrode binder, a cellulose-based compound capable of imparting viscosity may be further included. As the cellulose-based compound, one or more types of compounds, such as or including at least one of carboxymethyl cellulose, hydroxypropyl methyl cellulose, methyl cellulose, or alkali metal salts thereof, may be included in combination. As the alkali metal, at least one of Na, K, or Li may be included.

The dry binder is or includes a polymer material that may be fiberized, such as or including at least one of polytetrafluoroethylene, polyvinylidene fluoride, a polyvinylidene fluoride-hexafluoropropylene copolymer, polyethylene oxide, or a combination thereof.

The conductive material may be included to impart conductivity to the electrode, and in a configured battery, any electronically conductive material that does not cause a substantial chemical change in the battery may be included. Examples may include a carbon-based material such as or including at least one of natural graphite, artificial graphite, carbon black, acetylene black, Ketjen black, carbon fibers, carbon nanofibers, carbon nanotubes; a metal-based material including at least one of copper, nickel, aluminum, silver, and the like, and in the form of a metal powder or metal fiber; a conductive polymer such as a polyphenylene derivative; or a mixture thereof.

As the negative electrode current collector, at least one of a copper foil, a nickel foil, a stainless steel foil, a titanium foil, a nickel foam, a copper foam, a conductive metal-coated polymer substrate, and a combination thereof, may be included.

### Electrolyte (not Shown)

The electrolyte for the battery cell 100 may include a non-aqueous organic solvent and a lithium salt.

The non-aqueous organic solvent may be configured as a medium through which ions involved in the electrochemical reaction of the battery may move.

The non-aqueous organic solvent may be or include at least one of a carbonate-based, an ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. As the alcohol-based solvent, at least one of ethyl alcohol, isopropyl alcohol, and the like may be included, and as the aprotic solvent, at least one of nitriles such as R—CN (R is a straight, branched, or cyclic hydrocarbon group having 2 to 20 carbon atoms, and may include a double bond, an aromatic ring, or an ether group), amides such as dimethylformamide, dioxolanes such as 1,3-dioxolane or 1,4-dioxolane, sulfolanes and the like may be included.

The non-aqueous organic solvent may be included alone or in a combination of two or more.

In addition, when using a carbonate-based solvent, a cyclic carbonate and a chain carbonate may be mixed and included, and the cyclic carbonate and the chain carbonate may be mixed in a volume ratio in a range of about 1:1 to about 1:9.

The lithium salt is a substance that is dissolved in the organic solvent and is configured as a source of lithium ions within the battery, enabling the basic operation of the lithium battery and promoting the movement of lithium ions between the positive electrode and the negative electrode. Representative examples of the lithium salt may include one or more of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI)), LiC₄F₉SO₃, LiN(CₓF₂ₓ₊₁SO₂)(C_{y}F_{2y+1}SO₂) (x and y are integers from 1 to 20), lithium trifluoromethanesulfonate, lithium tetrafluoroethanesulfonate, lithium difluorobis(oxalato)phosphate (LiDFOB), and lithium bis(oxalato)borate (LiBOB).

### Separator 30

Depending on the type of battery cell 100, the separator 30 may be present between the positive electrode 10 and the negative electrode 20. As the separator 30, at least one of polyethylene, polypropylene, polyvinylidene fluoride, or a multilayered film of two or more layers thereof may be included, and a mixed multilayered film such as at least one of a polyethylene/polypropylene two-layer separator, a polyethylene/polypropylene/polyethylene three-layer separator, or a polypropylene/polyethylene/polypropylene three-layer separator may also be included as the separator 30.

The separator 30 may include a porous substrate and a coating layer including an organic material, an inorganic material, or a combination thereof located on one surface or both surfaces of the porous substrate.

The porous substrate may be or include a polymer film formed of or including a polymer, or a copolymer or mixture of two or more of polyolefins such as polyethylene or polypropylene, polyesters such as polyethylene terephthalate or polybutylene terephthalate, polyacetal, polyamide, polyimide, polycarbonate, polyether ketone, polyarylether ketone, polyetherimide, polyamideimide, polybenzimidazole, polyethersulfone, a polyphenylene oxide, a cyclic olefin copolymer, polyphenylene sulfide, polyethylene naphthalate, a glass fiber, Teflon, and polytetrafluoroethylene.

The organic material may include a polyvinylidene fluoride-based polymer or a (meth)acrylic-based polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic and inorganic materials may be present as a mixture in a single coating layer, or may be present in the form of a coating layer including the organic material and a coating layer including the inorganic material, which are laminated.

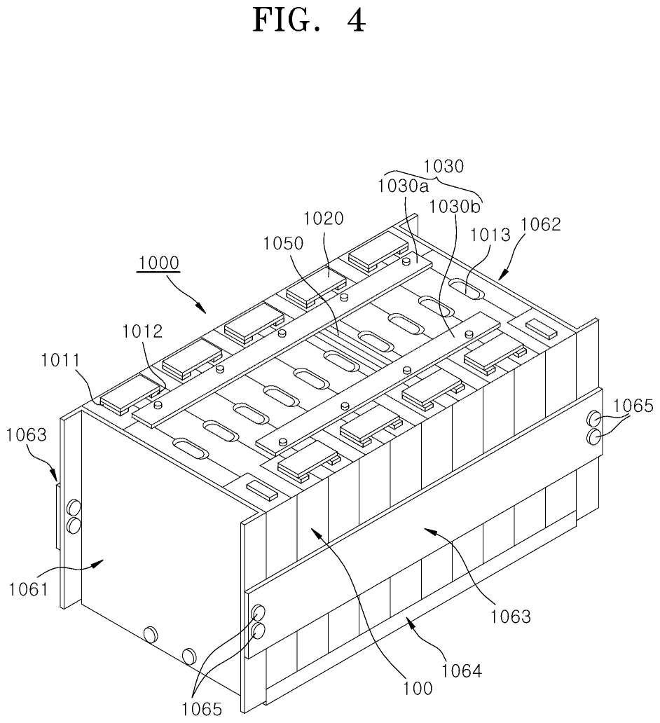

FIG. 4 is a view showing a battery module according to one example embodiment of the present disclosure;

A battery module 1000 according to one example embodiment of the present disclosure includes a plurality of battery cells 100, a housing 1061, 1062, 1063, 1064, and 1065 that accommodates the plurality of battery cells 100, and a bus bar that electrically connects at least some of the plurality of battery cells 100.

The plurality of battery cells 100 may include, for example, the battery cells described in FIGS. 1 to 3, and may be arranged and accommodated in one direction within the housing 1061 to 1065.

The housing 1061 to 1065 may include a pair of end plates 1061 and 1062 facing wide surfaces of the battery cells 100, and side plates 1063 and a bottom plate 1064 that connect the pair of end plates 1061 and 1062. The side plates 1063 may support side surfaces of the battery cell 100, and the bottom plate 1064 may support a bottom surface of the battery cell 100. In an example, the pair of end plates 1061 and 1062, the side plates 1063, and the bottom plate 1064 may be connected by a member such as, e.g., a bolt 1065.

The battery module 1000 includes terminal portions 1011 and 1012, a connecting tab 1020 connecting adjacent battery cells 100, and a protection circuit module 1030 with one end portion connected to the connecting tab 1020. The protection circuit module 1030 may be or include a battery management system (BMS). For example, the connecting tab 20 may be or include a bus bar.

Terminal portions 1011 and 1012 that are electrically connected to the connecting tab 1020 and a vent 1013 that is a passage for discharging gas generated internally may be provided on one side of the battery cell 100. The terminal portions 1011 and 1012 of the battery cell 100 may be, e.g., a positive terminal 1011 and a negative terminal 1012 with different polarities, and the terminal portions 1011 and 1012 of neighboring battery cells 100 may be electrically connected in series or in parallel by the connecting tab 1020 further described below. Meanwhile, although the above description was given as an example of serial connection, the present disclosure is not limited to this structure, and any connection structure can be adopted as desired. In addition, the number and arrangement of battery cells are not limited to the structure shown in FIG. 3, and can be modified as necessary.

The protection circuit module 1030 may have electronic components, protection circuits, and the like, mounted thereon, and may be electrically connected to the connecting tab 1020 described below. The protection circuit module 1030 may include a first protection circuit module 1030a and a second protection circuit module 1030b that extend at different positions in a direction in which a plurality of battery cells 100 are arranged, and in this case, the first protection circuit module 1030a and the second protection circuit module 1030b may be spaced a predetermined or desired distance from each other, located in parallel, and electrically connected to each adjacent connecting tab 20. For example, the first protection circuit module 1030a is formed to extend on one side of upper portions of the plurality of battery cells 100 in the direction in which the plurality of battery cells 100 are arranged, the second protection circuit module 1030b is formed to extend on the other side of the upper portions of the plurality of battery cells 100 in the direction in which the plurality of battery cells 100 are arranged, and the second protection circuit module 1030b is located at a predetermined or desired distance from the first protection circuit module 1030a with the vent 1013 interposed therebetween, but may be disposed parallel to the first protection circuit module 1030a. In this way, the two protection circuit modules are disposed to be spaced apart in parallel in the direction in which the plurality of battery cells 100 are arranged, thereby reducing or minimizing an area of a printed circuit board PCB constituting the protection circuit module 1030. Since the protection circuit module 1030 is configured separately as two protection circuit modules, it is possible to reduce or minimize an unnecessary PCB area. In addition, the first protection circuit module 1030a may be connected to the second protection circuit module 1030b by a conductive connecting member 1050. In this case, the connecting member 1050 may have one side connected to the first protection circuit module 1030a, and the other side connected to the second protection circuit module 1030b, so that the two protection circuit modules 1030a and 1030b may be electrically connected.

The above connection may be performed by any one of soldering, resistance welding, laser welding, and projection welding methods.

In addition, the connecting member 1050 may be or include, for example, an electrical wire. In addition, the connecting member 1050 may also be made of or include a material having elasticity or flexibility. By means of this connecting member 1050, the voltage, temperature, and current of the plurality of battery cells 100 can be checked and managed to ensure that the plurality of battery cells 100 are normal. For example, information such as a voltage, a current, and a temperature received by the first protection circuit module 1030a from connecting tabs adjacent thereto, and information such as a voltage, a current, and a temperature received by the second protection circuit module 1030b from connecting tabs adjacent thereto may be integrally managed by the protection circuit module through the connecting member.

In addition, when the battery cell 100 swells, an impact can be absorbed by the elasticity or flexibility of the connecting member 1050, thereby reducing or preventing the first and second protection circuit modules 1030 from being damaged.

In addition, the shape and structure of the connecting member 1050 are not limited to the shape and structure shown in FIG. 3.

In this way, since the protection circuit module 1030 is provided as the first and second protection circuit modules 1030a and 1030b, it is possible to reduce or minimize an area of the PCB constituting the protection circuit module, thereby securing space inside the battery module. This can improve work efficiency by facilitating not only a fastening operation of connecting the connecting tab 1020 to the protection circuit module 1030, but also a repair when an abnormality is detected in the battery module 1000.

The battery cell 100 according to one example embodiment of the present disclosure, and the battery module 1000 according to one example embodiment of the present disclosure including the plurality of battery cells 100 have been described with reference to FIGS. 1 to 4. Hereinafter, a method for improving heat propagation inside and outside the battery cell 100 and/or the battery module 1000 in which the plurality of battery cells 100 are located in close proximity is described.

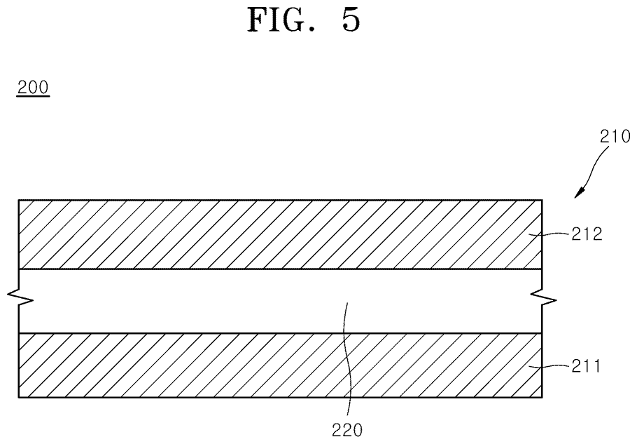

FIG. 5 is a cross-sectional view schematically showing an insulation sheet according to one example embodiment of the present disclosure;

As described in FIGS. 1 to 4, the battery module 1000 according to one example embodiment of the present disclosure includes the plurality of battery cells 100 that are arranged in parallel and connected in series or in parallel. The number of battery cells 100 included in the battery module 1000 may vary depending on the applications to which the battery module 1000 is applied.

The battery module 1000 may further include one or more insulation sheets 200. The insulation sheet 200 may be provided on one surface of at least one of the plurality of battery cells 100. The insulation sheet 200 may be provided on substantially the entire surface, a plurality of surfaces, and/or one surface side of the battery cell 100. For example, when the battery cell 100 surrounded by the insulation sheet 200 is adjacent to the housing 1061 to 1064, the insulation sheet 200 may be provided between the housing 1061 to 1064 and the battery cell 100.

The insulation sheet 200 may have a thin thickness and a tensile form such as, e.g., a thin plate, a thin film, or a sheet. Accordingly, the insulation sheet 200 may be readily applied to a narrow space such as between two battery cells 100, or between the battery cell 100 and the housing 1061, 1062, 1063, and 1064.

The insulation sheet 200 can improve heat propagation between the battery cells 100. For example, the insulation sheet 200 may insulate to hinder or prevent heat generated from the battery cell 100 surrounded by the insulation sheet 200 from escaping to the outside of the battery module 1000. For example, the insulation sheet 200 may insulate to hinder or prevent heat from the outside of the battery module 1000 from heading toward the battery cell 100 surrounded by the insulation sheet 200. For example, the insulation sheet 200 may hinder or block heat from propagating from one battery cell 100 to another battery cell 100 that is adjacent thereto.

For example, the insulation sheet 200 may include a first layer 210 and a second layer 220.

The first layer 210 may be or include a base material of the insulation sheet 200. The first layer 210 may allow the insulation sheet 200 to maintain the shape thereof. Alternatively, the first layer 210 may be configured as a barrier to hinder or block heat diffusion and/or flames. That is, the first layer 210 may have heat resistance and/or fire resistance functions. Due to the characteristics of the insulation sheet 200, components included in the insulation sheet 200 may not be deformed and/or lost due to heat, or should not damage adjacent battery cells 100 due to heat. That is, the components included in the insulation sheet 200 should be able to be maintained without structurally collapsing and/or being lost due to heat and/or flames. Accordingly, the insulation sheet 200 may have an insulation property and/or a heat resistance property while maintaining the shape thereof. To this end, the first layer 210 may include a refractory material.

For example, the refractory material may be or include at least one or a mixture of at least two of mica, vermiculite, talc, diatomaceous earth, bentonite, silicon, sericite, kaolin, polyimide, and polyethylene terephthalate.

The second layer 220 may be configured as an insulating layer that allows the insulation sheet 200 to have an insulation property. To this end, the second layer 220 may include an insulation material. The second layer 220 can reduce or suppress heat diffusion from one battery cell 100 to another battery cell 100 adjacent thereto.

For example, the insulation material may be or include at least one or a mixture of at least two of aerogel, wet silica, dry silica, polyurethane, polystyrene, polyethylene, and polyester.

The second layer 220 may be stacked on at least one surface of the first layer 210. In this case, the second layer 220 may be stacked on one surface of the first layer 210 while in contact with the one surface of the first layer 210. Alternatively, the second layer 220 may be stacked on one surface of the first layer 210 while being spaced apart from one surface of the first layer 210.

The second layer 220 may be or include, for example, a sheet. The second layer 220 may be formed by being attached to the first layer 210.

For example, the second layer 220 may be or include a slurry or solution. The second layer 220 may be formed by, e.g., being coated, sprayed, and/or applied onto the first layer 210.

For example, as shown in FIG. 5, the first layer 210 may be provided as two first layers. The second layer 220 may be located between the two first layers 210. For example, the first layer 210 may include a lower layer 211 and an upper layer 212. The second layer 220 may be formed on the lower layer 211. The upper layer 212 may be formed on the second layer 220. In an example, the second layer 220 may be formed only on a portion of the lower layer 211. In an example, the upper layer 212 may be formed on the lower layer 211 and may also be formed on the second layer 220 and a region in which the second layer 220 is not formed.

With this structure, for example, even when a thermal runaway phenomenon occurs inside the battery module 1000, the insulation sheet 200 according to the example embodiments can hinder or prevent heat propagation between the battery cells 100, and improve the safety of the battery cell 100 and/or the battery module 1000.

Hereinafter, various example embodiments of the insulation sheet 200 are described.

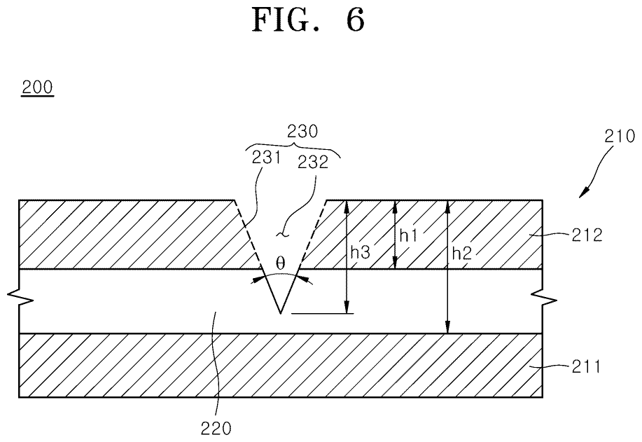

FIG. 6 is a cross-sectional view schematically showing an insulation sheet according to one example embodiment of the present disclosure; The insulation sheet 200 according to one example embodiment of the present disclosure may include one or more first layers 210 and one or more second layers 220. For example, the first layer 210 and the second layer 220 are formed by being alternately stacked.

For example, as shown in FIG. 5, the insulation sheet 200 may include two first layers 210, and a second layer 220 located between the two first layers 210.

For example, the first layer 210 may include a lower layer 211 and an upper layer 212 that are spaced apart from each other. The second layer 220 may be provided on the lower layer 211. For example, the second layer 220 may be applied on the lower layer 211 and coated on the lower layer 211. For example, the second layer 220 may be applied in the form of a water-based slurry on the lower layer 211 and coated on the lower layer 211. The second layer 220 may be applied on the entire area of an upper surface of the lower layer 211. In this case, the second layer 220, for example, as shown in FIG. 6, may be located in the entire region between the lower layer 211 and the upper layer 212. The upper layer 212 may be located on the second layer 220. That is, the lower layer 211 may be provided on a lower surface of the second layer 220, and the upper layer 212 may be provided on an upper surface of the second layer 220.

Therefore, the insulation sheet 200 may be provided in at least one of the gaps between the plurality of battery cells 100. That is, the insulation sheet 200 may be located on a cross-section of one side of each of one or more battery cells 100. Furthermore, the insulation sheet 200 may be formed in the form of an enclosure that surrounds a plurality of surfaces of each of one or more battery cells. For example, the insulation sheet 200 may be assembled in any form while surrounding two or more surfaces of the battery cell 100. For example, the insulation sheet 200 may further include a bending portion 230 on at least one surface.

The bending portion 230 may be formed on at least one surface of the insulation sheet 200.

For example, the bending portion 230 may be formed by passing through the first layer 210 formed on one surface of the second layer 220. The bending portion 230 may form a through-hole 231 in one first layer 210. For example, the through-hole 231 may be formed to become narrower from a surface of the first layer 210 toward the second layer 220. For example, as shown in FIG. 6, the bending portion 230 may be formed by passing through the upper layer 212 formed on an upper surface of the second layer 220. For example, the bending portion 230 may form the through-hole 231 in the upper layer 212. However, unlike as shown in FIG. 6, the bending portion 230 may also be formed by passing through the lower layer 211 formed on a lower surface of the second layer 220, and the bending portion 230 may form a through-hole in the lower layer 211.

The bending portion 230 may form a first groove 232 on one side of the second layer 220. For example, the first groove 232 may be formed in a shape that becomes narrower from one side of the second layer 220 toward the inside of the second layer 220. For example, the first groove 232 may be formed in an inverted cone shape, as shown in FIG. 6. In this case, at least a portion of the first groove 232 may be connected to the through-hole 231. That is, the through-hole 231 and the first groove 232 may be connected to each other to form an inverted cone shape. In this case, a cross-section of the inverted cone shape may be any shape of a circular shape, a polygonal shape, an amorphous shape, and the like.

The bending portion 230 may be formed on one side of the insulation sheet 200 to expose the first layer 210 and the second layer 220. The first layer 210 may be exposed to the outside through an inner surface of the through-hole 231. The second layer 220 may be exposed to the outside through an inner surface of the first groove 232.

The bending portion 230 may be formed to expose, for example, portions of the second layer 220 and of the upper layer 212, which is the first layer provided on one side of the second layer 220. For example, the bending portion 230 may be formed so that no through-hole is formed in the second layer 220. For example, the bending portion 230 may be formed so that the lower layer 211, which is the first layer provided on the other surface of the second layer 220, is not exposed to the outside through the bending portion 230.

For example, the upper layer 212 of the first layer 210 may have a first height h1. A height of the second layer 220 including the upper layer 212 may be a second height h2. The bending portion 230 may have a third height h3. In this example, the third height h3 may be greater than the first height h1 and less than the second height h2.

The bending portion 230 may be assembled by being bent in the form that surrounds the battery cell 100 in the battery module 1000 and/or a battery pack (not shown). Therefore, the third height h3 may be formed between the first height h1 and the second height h2 in consideration of mechanical properties such as dust resistance of the upper layer 212 of the first layer 210 or the second layer 220 and/or desired insulation properties and spatial design of the bending portion.

For example, the bending portion 230 may be formed at an angle θ of about 0 degrees or more to about 30 degrees or less. In addition, the bending portion 230 may have a height that is greater than the first height h1 and less than the second height h2. Therefore, even when the insulation sheet 200 is bent by the bending portion 230, the second layer 220 can further support the first layer 210. For example, even when the insulation sheet 200 is bent due to the bending portion 230, the second layer 220 can further firmly maintain the first layer 210, thereby further improving the insulation property and/or fire resistance property of the insulation sheet 200.

In examples, the description of the bending portion 230 is not limited thereto. For example, the first layer 210 and/or the second layer 220 may have a substantial mechanical strength and/or relatively poor dust resistance. Alternatively, the battery module 1000 may require an additional space at the bending portion 230 for other components. As such, in cases where a process work environment and/or ease of process work is required, the bending portion 230 may be formed at an angle θ of about 30 degrees or more and/or have a height equal to the second height h2 or more.

With this structure, one example embodiment of the present disclosure may provide the insulation sheet 200 including an insulation material and in which the bending portion is formed. The insulation sheet 200 may be attached to substantially the entire surface of an outer surface of the battery cell 100 using only one insulation sheet 200 through the bending portion 230. For example, the insulation sheet 200 may have the bending portion 230 formed at a position that matches the area and/or shape of each surface of the battery cell 100. Accordingly, the insulation sheet 200 can be cut and utilized in various ways according to the desired area. In addition, due to such features, the insulation sheet 200 can be provided on a plurality of surfaces of the battery cell 100 through one insulation sheet 200.

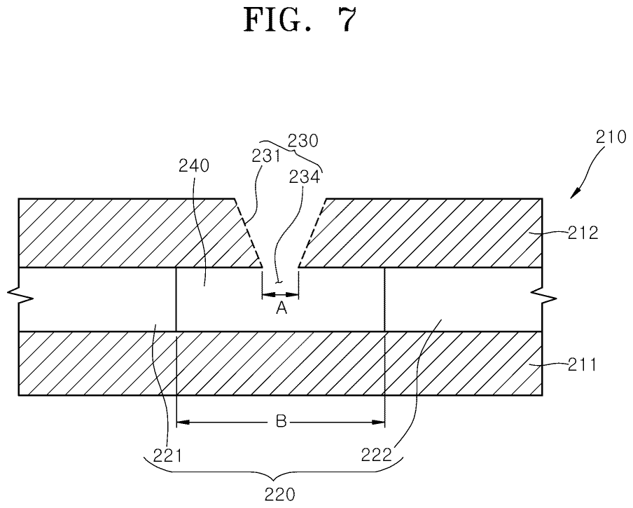

FIG. 7 is a cross-sectional view schematically showing an insulation sheet according to one embodiment of the present disclosure;

The insulation sheet 200 according to one example embodiment of the present disclosure may include one or more first layers 210 and one or more second layers 220. For example, the first layer 210 and the second layer 220 are alternately stacked. In addition, the insulation sheet 200 may further include a bending portion 230 on at least one surface.

For example, as shown in FIGS. 5 and 6, the insulation sheet 200 may include two first layers 211 and 212 and a second layer 220 located between the two first layers 211 and 212.

For example, the second layer 220 may be located in a portion of a region between the two first layers 211 and 212. For example, the second layer 220 may include a left layer 221 and a right layer 222 that are located on the lower layer 211 and spaced apart at a given distance from each other. In this case, the terms left and right are included to readily indicate the distribution of the second layer 220 on a cross-sectional view, and the distribution position of the second layer 220 is not limited by these terms. Therefore, the second layer 220 may have any form on the first layer 210 except for a space that forms a central cavity when viewed from above. Therefore, the second layer 220 may form a cavity 240 between the two first layers 210. That is, the cavity 240 may be formed by the left layer 221, the right layer 222, the lower layer 211, and the upper layer 212. In this case, a length B between the left layer 221 and the right layer 222 in the cavity 240 may be equal to a length A of a lower end of the bending portion 230, or less than about 500% of the length A of the lower end. In this case, the length A of the lower end of the bending portion 230 indicates a width of a passage connecting the bending portion 230 to the cavity 240.

For example, the bending portion 230 may pass through the upper layer 212 formed on one surface of the second layer 220. The bending portion 230 may connect the cavity 240 to the outside via the through-hole 231 passing through the upper layer 212. That is, the bending portion 230 may allow the cavity 240 to be exposed to the outside.

With this structure, one example embodiment of the present disclosure can reduce or prevent the second layer 220 from being exposed to the bending portion 230. Accordingly, one example embodiment of the present disclosure can reduce or prevent dust from being generated from the second layer 220.

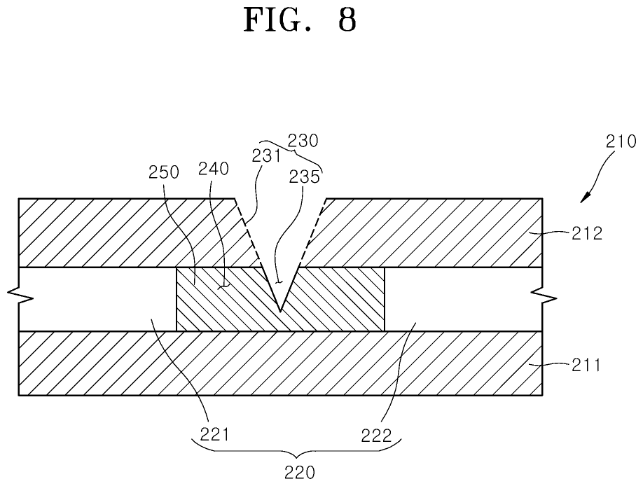

FIG. 8 is a cross-sectional view schematically showing an insulation sheet according to one example embodiment of the present disclosure;

The insulation sheet 200 according to one example embodiment of the present disclosure may include one or more first layers 210 and one or more second layers 220. For example, the first layer 210 and the second layer 220 are formed by being alternately stacked. In addition, the insulation sheet 200 may further include a bending portion 230 on at least one surface of the one or more first layers 210.

For example, as shown in FIGS. 5 to 7, the insulation sheet 200 may include two first layers 210 referred to as upper layer 212 and lower layer 211, and a second layer 220 located between the upper layer 212 and the lower layer 211.

For example, the second layer 220 may be located in a portion of a region between the upper layer 212 and the lower layer 211. With this distribution, the second layer 220 may form a cavity 240 between the upper layer 212 and the lower layer 211. The cavity 240 may be the same as, or similar to, the cavity described with respect to FIG. 7.

The insulation sheet 200 may further include a filler 250 that fills the cavity 240. The filler 250 may include, for example, a heat-resistant material and/or an adhesive material. For example, the filler 250 may include at least one of a thermosetting elastomer, a thermoplastic elastomer, and a combination thereof. In this case, the thermosetting elastomer may include at least one of silicone rubber, urethane rubber, isoprene rubber, natural rubber, ethylene-propylene rubber, ethylene-propylene-diene rubber, nitrile rubber, and styrene-butadiene rubber. In this case, the thermoplastic elastomer may include at least one of urethane-based, ester-based, styrene-based, olefin-based, butadiene-based, and fluorine-based elastomers.

The filler 250 may fill all or part of the cavity 240. For example, the filler 250 may be coated on a side surface of the second layer 220 along an inner surface of the cavity 240. Alternatively, the filler 250 may fill, for example, substantially the entire cavity 240.

For example, the bending portion 230 may pass through the first layer 210 formed on one surface of the second layer 220. The bending portion 230 may form a second groove 235 on one surface of the filler 250. The bending portion 230 may allow the second groove 235 to be exposed to the outside.

In this case, the shape of the second groove 235 may be the same as or similar to the shape of the first groove 232. However, unlike the first groove 232, the second groove 235 may not have a shape connected to the through-hole 231.

With this configuration, one example embodiment of the present disclosure can reduce or prevent the second layer 220 from being exposed to the bending portion 230. Accordingly, one example embodiment of the present disclosure can further hinder or prevent dust from being generated from the second layer 220.

Referring back to FIGS. 5 to 8, the insulation sheet 200 according to one example embodiment of the present disclosure includes one bending portion 230 on one surface thereof. In examples, unlike as shown in FIGS. 5 to 8, the insulation sheet 200 may include at least one bending portion 230 on at least one surface thereof. For example, the bending portion 230 may include a first bending portion formed on one surface of the insulation sheet 200 and a second bending portion that is formed on one surface of the insulation sheet 200 and is spaced apart from the first bending portion. In this case, a distance between the first bending portion and the second bending portion may correspond to a length of one surface of the battery cell 100.

Hereafter, an example in which the insulation sheet 200 described in FIGS. 5 to 8 is applied to the battery cell 100 is described.

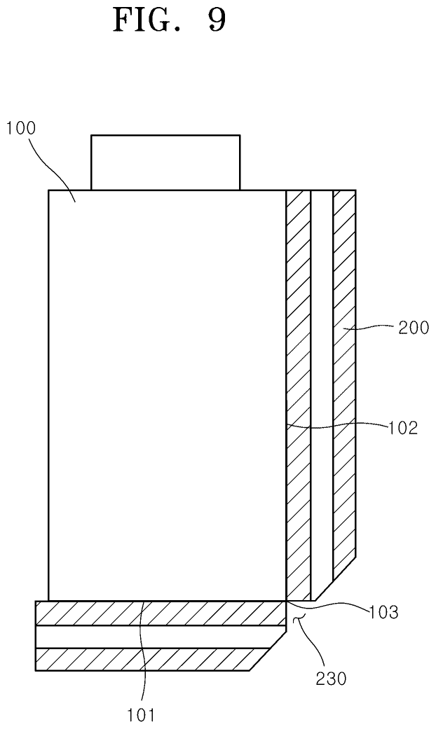

FIG. 9 is a view schematically showing an example in which the insulating sheet according to one example embodiment of the present disclosure is applied to the battery cell.

FIG. 9 shows one battery cell 100 among the plurality of the battery cells 100 included in the battery module 1000 according to one example embodiment of the present disclosure. In addition, FIG. 9 shows an example in which the insulation sheet 200 described in FIGS. 5 to 8 is applied to at least one surface of the battery cell 100.

FIG. 9 shows an example in which the insulation sheet 200 according to one example embodiment of the present disclosure is applied to the battery cell 100 according to one example embodiment of the present disclosure.

The battery cell 100 may include a first surface 101, a second surface 102 adjacent to the first surface 101, and a corner 103 connecting the first surface 101 to the second surface 102.

As shown in FIG. 9, the insulation sheet 200 may be located on the battery cell 100 so that the bending portion 230 is provided on the corner 103. The bending portion 230 may be bent along the corner 103. Accordingly, the insulation sheet 200 may surround the first surface 101 and the second surface 102 even with one sheet.

Unlike as shown in FIG. 9, the insulation sheet 200 may simultaneously or contemporaneously surround three or more surfaces of the battery cell 100. For example, the insulation sheet 200 may include a first bending portion and a second bending portion. In addition, for example, the battery cell 100 may include a first surface, a second surface that is adjacent to the first surface and connected by a first corner, and a third surface that is adjacent to the first surface and connected by a second corner. When the battery cell 100 has a polyhedral shape, the second surface and the third surface may be facing each other. The insulation sheet 200 may be located on the battery cell 100 so that the first bending portion is provided on the first corner and the second bending portion is provided on the second corner. The first bending portion may be bent along the first corner. The second bending portion may be bent along the second corner. Accordingly, the insulation sheet 200 may surround the first surface, the second surface, and the third surface even with one sheet.

In FIGS. 1 to 9, one example embodiment of the present disclosure has described the insulation sheet 200 that may be bent through the bending portions to simultaneously or contemporaneously surround multiple surfaces and the battery module 1000 to which the insulation sheet 200 is applied. With this structure, the insulation sheet 200 can be cut and applied in various ways according to the desired enclosing area. In addition, the insulation sheet 200 may further improve heat propagation through fire-resistant and/or thermal insulating structures.

An insulation sheet and/or a battery module including the insulation sheet according to the present disclosure can improve heat propagation between adjacent cells.

An insulation sheet and/or a battery module including the insulation sheet according to the present disclosure can improve fire resistance and/or insulation properties.

An insulation sheet and/or a battery module including the insulation sheet according to the present disclosure can provide a dust improvement effect.

According to the present disclosure, it is possible to provide an insulation sheet and/or a battery module including the insulation sheet, which is capable of enclosing a battery cell through one insulation sheet.

According to the present disclosure, it is possible to provide an insulation sheet and/or a battery module including the insulation sheet, which is capable of being cut into various areas and/or shapes.

However, the effects that can be achieved through the present disclosure are not limited to the above-described effects, and other technical effects not mentioned are clearly understood by those skilled in the art from the description of the disclosure described below.

Although the present disclosure has been described above with limited examples and drawings, the present disclosure is not limited thereto, and various modifications and variations may be made by those skilled in the art to which the present disclosure belongs within the technical idea of the present disclosure and the equivalent scope of the patent claims described below.

What is claimed is:

1. An insulation sheet comprising:
two first layers; and
a second layer located between the two first layers and including an insulation material,
wherein at least one surface of the insulation sheet comprises a bending portion.

2. The insulation sheet of claim 1, wherein the second layer is located in substantially the entire region between the two first layers.

3. The insulation sheet of claim 2, wherein the bending portion passes through the first layer formed on one surface of the second layer and forms a first groove on one surface of the second layer so that the first groove is exposed to an outside of the insulation sheet.

4. The insulation sheet of claim 1, wherein the second layer is located in a portion of a region between the two first layers to form a cavity between the two first layers.

5. The insulation sheet of claim 4, wherein the bending portion passes through the first layer formed on one surface of the second layer so that the cavity is exposed to an outside of the insulation sheet.

6. The insulation sheet of claim 4, further comprising a filler that substantially fills the cavity.

7. The insulation sheet of claim 6, wherein the bending portion passes through the first layer formed on one surface of the second layer and forms a second groove on one surface of the filler so that the second groove is exposed to an outside of the insulation sheet.

8. The insulation sheet of claim 1, wherein the bending portion comprises:
a first bending portion on one surface of the insulation sheet, and
a second bending portion on one surface of the insulation sheet and spaced apart from the first bending portion.

9. A battery module comprising:
a plurality of battery cells; and
an insulation sheet surrounding at least a portion of at least one of the plurality of battery cells,
wherein the insulation sheet includes:
two first layers; and
a second layer located between the two first layers and including an insulation material, and
at least one surface of the insulation sheet comprises a bending portion.

10. The battery module of claim 9, wherein:
at least one of the plurality of battery cells includes a first surface, a second surface adjacent to the first surface, and a corner connecting the first surface to the second surface, and
the insulation sheet has the bending portion provided on the corner to surround the first surface and the second surface.

11. The battery module of claim 9, wherein the second layer is located in substantially the entire region between the two first layers, and
the bending portion passes through the first layer formed on one surface of the second layer and forms a first groove on one surface of the second layer so that the first groove is exposed to an outside of the insulation sheet.

12. The battery module of claim 9, wherein the second layer is located in a portion of a region between the two first layers to form a cavity between the two first layers.

13. The battery module of claim 12, wherein the bending portion passes through the first layer formed on one surface of the second layer so that the cavity is exposed to an outside of the insulation sheet.

14. The battery module of claim 12, wherein the insulation sheet further comprises a filler that substantially fills the cavity.

15. The battery module of claim 14, wherein the bending portion passes through the first layer formed on one surface of the second layer, and forms a second groove on one surface of the filler so that the second groove is exposed to an outside of the insulation sheet.
